(19) United States
(12) Patent Application Publication
(10) Pub. No.: US 2010/0294224 A1
(43) Pub. Date: Nov. 25, 2010

(54) METHOD FOR STARTING AN ENGINE, AND AN ENGINE

(75) Inventor: Kenth I. Svensson, Hagerstown, MD (US)

Correspondence Address: WRB-IP LLP, 801 N. Pitt Street, Suite 123, ALEXANDRIA, VA, 22314, US

(73) Assignee: Mack Trucks Inc., Greensboro, NC (US)

(21) Appl. No.: 12/864,314

(22) PCT Filed: Jan. 29, 2008
(86) PCT No.: PCT/US08/52321

§ 371 Date: Jul. 23, 2010

(51) Int. Cl. F02M 1/00

(52) U.S. Cl. 123/179.16

(57) ABSTRACT

A method for starting an engine includes reciprocating a piston in a cylinder through a plurality of reciprocating movements between the TDC and the BDC positions with the exhaust valve closed for longer than during the normal combustion cycle and the intake valve open for at least part of at least one of a compression movement and an exhaust movement while the exhaust valve is closed. An engine is also disclosed.

### BACKGROUND AND SUMMARY

The present invention relates to a method for starting an engine, and an engine, and more particularly to a method for starting a cold engine.

Internal combustion engines have certain conditions under which their operation is optimal, and certain conditions under which their operation is less than optimal. For example, combustion of fuel in cylinders of diesel engines may not occur when temperatures are too low. The typical solution to this problem has been heating of the air supply, such as by air heaters proximate the intake manifold or glow plugs. It is desirable to provide a means of heating air that does not require additional equipment.

According to an aspect of the present invention, a method for starting an engine is provided. The engine comprises at least one cylinder arrangement comprising a cylinder with at least one intake valve and at least one exhaust valve, a fuel injector for injecting fuel into the cylinder, a piston adapted to reciprocate in the cylinder between a TDC position and a BDC position through an intake movement, a compression movement, an expansion movement, and an exhaust movement, and means for opening and closing the exhaust valve, the opening and closing means opening and closing the exhaust valve according to a normal combustion cycle during normal operation of the engine. The method comprises reciprocating the piston in the cylinder through a plurality of reciprocating movements between the TDC and the BDC positions with the exhaust valve closed for longer than during the normal combustion cycle and the intake valve open for at least part of at least one of the compression movement and the exhaust movement while the exhaust valve is closed.

According to another aspect of the present invention, an engine comprises a cylinder arrangement including a cylinder, an intake valve and an exhaust valve for opening and closing flow communication with the cylinder, a piston adapted to reciprocate between a TDC position and a BDC position in the cylinder through an intake movement, a compression movement, an expansion movement, and an exhaust movement, a fuel injector adapted to inject fuel into the cylinder, and means for opening and closing the exhaust valve, the opening and closing means opening and closing the exhaust valve according to a normal combustion cycle during normal operation of the engine. A controller is adapted to control fuel injection into the cylinder and opening and closing of the intake valve and the exhaust valve, the controller being arranged to maintain the exhaust valve in a closed position for longer than during the normal combustion cycle and the intake valve open for at least part of at least one of the compression movement and the exhaust movement while the exhaust valve is closed while the piston is reciprocated in the cylinder through a plurality of reciprocating movements between the TDC and the BDC positions.

### BRIEF DESCRIPTION OF THE DRAWINGS

The features and advantages of the present invention are well understood by reading the following detailed description in conjunction with the drawings in which like numerals indicate similar elements and in which:

FIGS. 1a-1m schematically show a cylinder arrangement for an engine according to an aspect of the present invention during different phases of an operating cycle of the engine;

FIG. 2 schematically shows an engine according to an aspect of the present invention including a plurality of cylinder arrangements; and

FIG. 3 is a flow chart showing steps involved in a cold start operation according to an aspect of the present invention.

### DETAILED DESCRIPTION

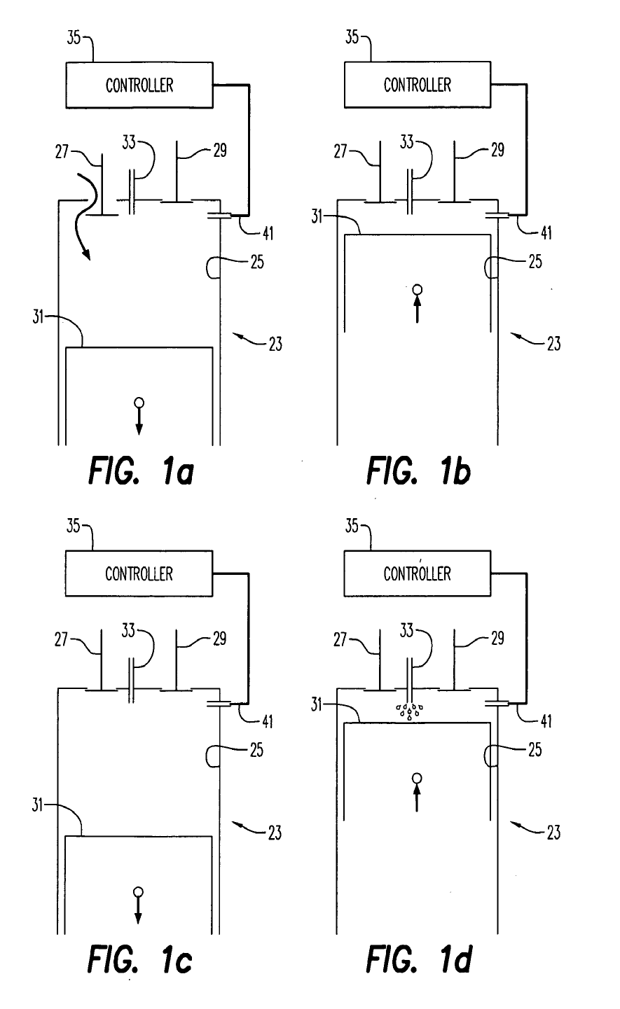

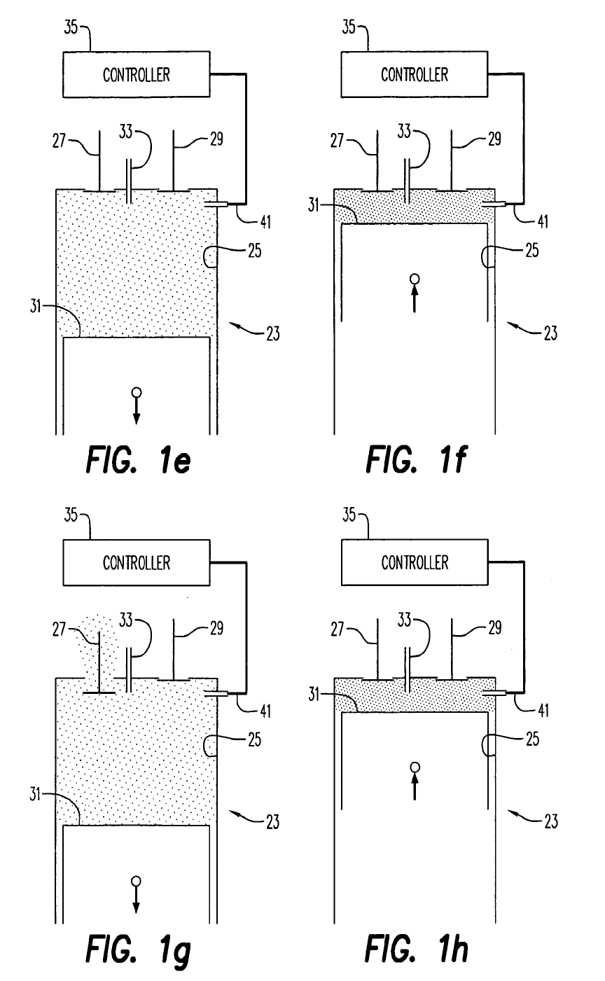

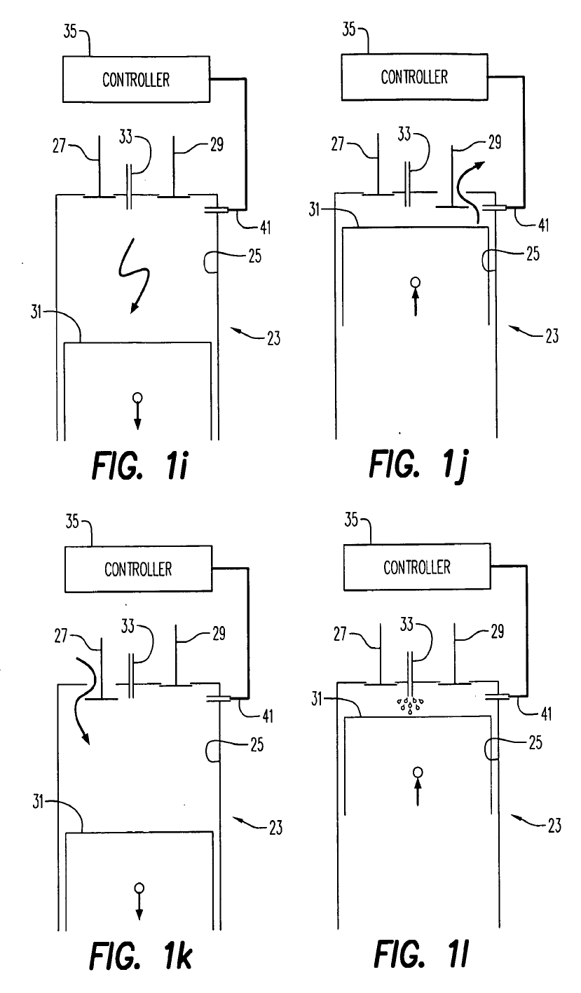

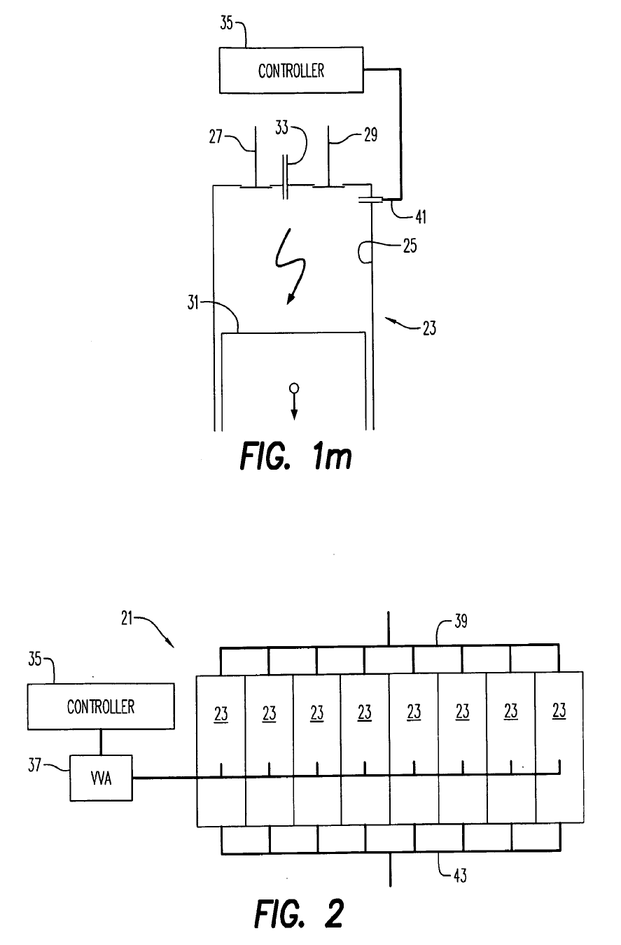

FIGS. 1a-1m show a cylinder arrangement 23 of an engine 21 (FIG. 2) according to an aspect of the present invention. While aspects of the present invention are adapted for use in connection with any type of engine, it is presently contemplated that aspects of the invention will be particularly well-suited for use in connection with compression ignition engines and, except where otherwise noted, a diesel engine and method is described for purposes of illustration.

The engine 21 includes at least one cylinder arrangement 23. Each cylinder arrangement 23 can include a cylinder 25, and an intake valve 27 and an exhaust valve 29 for opening and closing flow communication with the cylinder. The cylinder arrangement 23 can also include a piston 31 adapted to reciprocate between a top dead center (TDC) position (such as is seen in FIGS. 1b, 1d, 1f, 1h, 1j, and 1l) and a bottom dead center (BDC) position (such as is seen in FIGS. 1a, 1c, 1e, 1g, 1i, 1k, and 1m) in the cylinder 25, and a fuel injector 33 adapted to inject fuel (from a fuel source, not shown) into the cylinder.

The engine 21 also includes a controller 35, such as a conventional Electronic Control Unit, ordinarily comprising a computer. The controller 35 is adapted to control fuel injection into the cylinder and to control opening and closing of the intake valve 27 and the exhaust valve 29, such as by controlling operation of a variable valve actuator (VVA) 37 or by a conventional cam and rocker arm arrangement (not shown) wherein the controller controls opening and closing by changing and freezing position(s) of the rocker arm(s).

The controller 35 can be further arranged, such as by being programmed, to maintain the exhaust valve 29 in a closed position, as seen in FIGS. 1a-1g, while the piston 31 is reciprocated in the cylinder 25 through a plurality of reciprocating movements between the TDC and the BDC positions, the reciprocating movements including an intake movement, a compression movement, an expansion movement, and an exhaust movement. The controller 35 can also be arranged to maintain the exhaust valve 29 in a closed position while the piston is reciprocated between the TDC and BDC positions for longer than the exhaust valve would be closed during normal operation of the engine. “Longer” in the sense used here means for a longer fraction of the combustion cycle, and not necessarily longer in the sense of elapsed time. Embodiments of the engine wherein the exhaust valve 29 is closed for the entire time of the reciprocation of the piston are illustrated for purposes of discussion, however, it will be appreciated that, consistent with an aspect of the invention, the controller 35 may open the exhaust valve for some portion of the reciprocating movement less than during normal operation of the engine instead of keeping it closed for the entire movement. References to the exhaust valve being “closed” will be understood to encompass when the exhaust valve is closed for an entire combustion cycle, as well as for longer than during the normal combustion cycle, except where otherwise indicated. The expression “reciprocating movement” is intended to mean a movement from TDC to BDC to TDC or a movement from BDC to TDC to BDC, not just a movement from TDC to BDC or from BDC to TDC. The controller 35 may be arranged to control reciprocation of the piston 31 in any suitable manner, such as by operating a conventional starter arrangement to turn a crankshaft (not shown) which, in turn, causes reciprocation of the piston.

The controller 35 may also be arranged to control opening and closing of the intake valve 27 for different lengths of time, i.e., longer or shorter durations, than during normal combustion. The controller 35 will, howver, maintain the intake valve 27 open during at least one of the compression movement and/or the exhaust movement when the exhaust valve is closed to minimize any “air spring” effect. For example, the controller 35 may control the intake valve 27 to remain open for a longer period to facilitate flow communication with an intake manifold of the engine. The controller 35 may control the intake valve 27 to remain completely open or completely closed for one or more reciprocating movements of the piston.

During each compression stroke with the intake valve 27 closed, air in the cylinder 25 is compressed and thereby heated. During a subsequent intake stroke, air in the cylinder 25 that had been compressed and heated is generally at a higher temperature than cooler air outside of the cylinder (such as air in an intake manifold 39 (FIG. 2)) and may flow out of the cylinder and thereby warm air outside of the cylinder, such as in the intake manifold. Because intake air and the compressed, heated air in the cylinder 25 is not exhausted through the closed exhaust valve 29 during the compression stroke and, during each reciprocating movement of the piston 31, the air in the cylinder becomes warmer.

The piston 31 can be reciprocated a predetermined number of times with the exhaust valve 29 closed until it is expected that temperatures in the cylinder 25 are sufficiently high for ignition to occur. For example, modeling can be performed for different engines at different temperatures to determine how many cycles the piston 31 must be reciprocated in the cylinder 25 for the temperature in the cylinder to reach a predetermined temperature at which it is expected that ignition will occur. The controller 35 can receive a signal corresponding to the ambient temperature and can cause the exhaust valve 29 to stay closed until the cylinder 25 has been reciprocated through a predetermined number of reciprocating movements and it is expected that a temperature in the cylinder 25 is sufficiently high. In this way, hydrocarbon emissions during start-up can be reduced because there will be reduced exhausting of cylinders that contained fuel that did not ignite because of low temperatures.

Alternatively or in addition to modeling of temperature rise in the cylinder 25, a temperature sensor 41 for sensing temperature in or proximate the cylinder 25 can be provided. The temperature sensor 41 may include a probe that is disposed in the cylinder 25 or the temperature sensor may be disposed outside of the cylinder, such as in the intake manifold 39. Temperature sensors 41 can, of course, be provided in both the cylinder 25 and the intake manifold 39, or in some other suitable location. The temperature sensor 41 can send a signal to the controller 35 corresponding to the temperature in the cylinder 25. The controller 35 can be arranged to control the fuel injector 33 to inject fuel only after the temperature in the cylinder 25 has reached a predetermined temperature, usually a temperature at which it is expected that ignition will occur. In this way, hydrocarbon emissions during start-up can be reduced because there will be reduced exhausting of cylinders that contained fuel that did not ignite because of low temperatures.

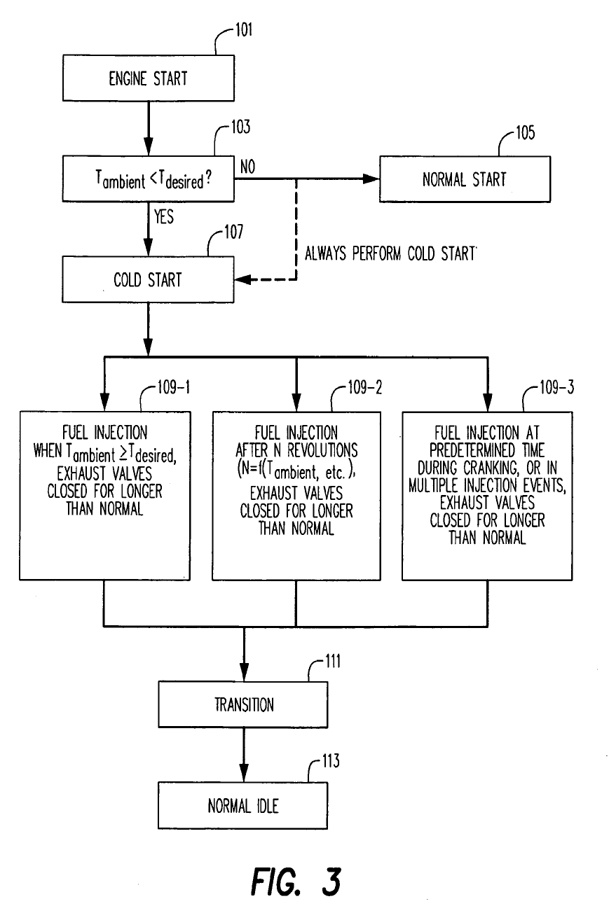

As seen in FIG. 3, when an engine start command is provided to an engine at step 101, another temperature sensor (not shown) may be provided to sense ambient temperature at step 103. The controller 35 can be programmed to start the engine according to a normal start-up procedure as shown at step 105 when ambient temperatures are equal to or greater than some predetermined desired temperature. Of course, the controller 35 can also be programmed to always start the engine by a “cold start” procedure as described herein, wherein the exhaust valve 29 is closed for longer than during a normal combustion cycle, as shown by phantom lines in FIG. 3. The engine can commence cold start operation at step 107 in FIG. 3.

There are several options by which fuel injection can occur, as illustrated by three such options shown at steps 109-1, 109-2, and 109-3, which are intended to be illustrative of the manner in which fuel can be injected, and not restrictive. Fuel can be injected at step 109-1 after the controller 35 has controlled closing of the exhaust valve 29 so that the T_{measured} at or near the cylinders is equal to or greater than a T_{desired}. Alternatively, fuel can be injected at step 109-2 after the controller 35 has controlled closing of the exhaust valve 29 for a number of reciprocating movements, the number N being calculated as a function of variables that may include one or more of T_{ambient}, P_{ambient}, or boost pressure P_{boost}. Yet another alternative is for fuel to be injected at step 109-3 at some predetermined time while the controller 35 controls closing of the exhaust valve 29, such as during a first (or subsequent) reciprocating movement during cranking, or via multiple injection events.

As seen in FIGS. 1i-1m, the controller 35 can be arranged to control opening and closing of the intake valve 27 and the exhaust valve 29 according to a normal combustion cycle after maintaining the exhaust valve closed until the temperature is at a predetermined temperature or for a predetermined number or cycles, usually for at least one reciprocating movement of the piston after injecting fuel as seen in FIGS. 1d-1g. Also, the controller 35 can be arranged to control opening and closing of the intake valve 27 and the exhaust valve 29 according to a cycle that differs from normal operation. By reciprocating the piston 31 with the exhaust valve 29 closed, the injected fuel will tend to pre-mix with the air and is better able to ignite when the intake valve 27 and the exhaust valve are closed (as seen in FIGS. 1h (showing compression of pre-mixed fuel) and 1i (showing combustion)) than if the fuel is injected as a spray while the piston is at or near TDC with both the intake valve and the exhaust valve closed as in a conventional combustion operation (as seen in FIG. 1l). In addition, because the piston 31 has been through one or more reciprocating movements in the cylinder 25, the temperature of the mixture in the cylinder is warmer and the mixture is ordinarily better adapted to ignite.

It will be appreciated that the piston 31 can be reciprocated with the exhaust valve 29 closed a plurality of times after fuel injection (i.e., the movements shown in FIGS. 1e-1g can be repeated a plurality of times) which can facilitate mixing of the fuel and air. It will further be appreciated that fuel injection can occur during an initial reciprocating movement of the piston and need not be preceded by a reciprocating movement of the piston prior to fuel injection (i.e., the movements shown in FIGS. 1a-1b can be omitted). If fuel is injected during an early cycle, at some point, the charge ignites and will heat the intake manifold 39 more than if uncharged air were just compressed. However, by waiting until the temperature in the cylinder 25 has reached some predetermined level prior to fuel injection, the piston 31 can be moved through a minimal number of reciprocating movements prior to combustion and subsequent to fuel injection which can minimize entry of injected fuel into the intake manifold from the cylinder 25.

As seen in FIG. 2, the engine 21 typically comprises a plurality of cylinder arrangements 23. The cylinders 25 of each cylinder arrangement 23 are typically adapted to be in flow communication with an intake manifold 39 via the intake valves 27 and with an exhaust manifold 43 via the exhaust valves 29. During an intake stroke of the pistons 31 in the cylinders 25 with the intake valve 27 open and the exhaust valve 29 closed, heated air from the cylinders tends to be at a higher pressure than cooler air in the intake manifold 39, which may result in some of the heated air flowing into the intake manifold and mixing with air from other cylinders prior to being drawn back into a cylinder during a subsequent intake stroke. If fuel is injected, the air and fuel from every other cylinder 25 can mix with the air and fuel from each other cylinder 25 in the intake manifold. In this way, the temperature and the air/fuel mixture can be more homogenized in each cylinder 25, and some warming of the intake manifold and ports will tend to occur. Also, because the exhaust valve 29 is closed during the start-up operation, energy is not wasted in heating the exhaust manifold or other components downstream of the cylinder arrangements 23.

A method is provided for starting an engine 21, particularly a diesel engine, that comprises at least one cylinder arrangement 23 comprising a cylinder 25 with at least one intake valve 27 and at least one exhaust valve 29, at least one fuel injector 33 for injecting fuel into the cylinder, and a piston 31 adapted to reciprocate in the cylinder between a TDC position and a BDC position. According to the method, the piston 31 is reciprocated in the cylinder 25 through a plurality of reciprocating movements between the TDC and the BDC positions with the exhaust valve closed 29 (i.e., closed entirely or for longer than during the normal combustion cycle).

According to one aspect of the method, no fuel is injected into the cylinder 25 during at least one initial reciprocating movement of the piston as seen in FIGS. 1a-1c. Afterward, fuel is injected into the cylinder 25 as seen in FIG. 1d. The exhaust valve 29 kept closed for at least one reciprocating movement of the piston 31 after injecting fuel, as seen in FIGS. 1e-1g. When both the intake valve 27 and the exhaust valve 29 are closed after fuel injection, if the temperature in the cylinder 25 is sufficiently high and the compression of the air/fuel mixture is sufficiently great, proximate the piston 31 reaching a TDC position as seen in FIG. 1h, combustion of the fuel will occur as seen in FIG. 1i. The intake valve 27 and the exhaust valve 29 can then be opened and closed according to a normal combustion cycle as seen in FIG. 1i-1m after maintaining the exhaust valve closed for the at least one reciprocating movement of the piston after injecting fuel. The temperature sensor 41 can sense the temperature in the cylinder 25 and the opening and closing the intake valve 27 and the exhaust valve 29 according to the normal combustion cycle as in FIGS. 1i-1m can be caused to occur only after a sensed temperature reaches a predetermined temperature.

According to another aspect of the method, a temperature sensor 41 can sense temperature in the cylinder 25 and fuel injection as seen in FIG. 1d can be caused to occur only after a sensed temperature reaches a predetermined temperature. Either immediately after fuel injection or after one or more reciprocating movements of the piston (ordinarily with no additional fuel injection), the intake valve 27 can be closed as at FIG. 1h and, if conditions such as equivalence ratio and temperature are sufficient, proximate the TDC position, the fuel will ignite. Subsequently, the intake valve 27 and the exhaust valve 29 can be opened and closed according to a normal combustion cycle, or there can be a transition at step 111 in FIG. 3 from cold start-up operation to normal operation, e.g., normal idle at step 113. The transition may take any suitable form, such as switching to a normal combustion cycle and fuel injection in selected cylinders while continuing in “cold start” mode in others; increasing the length of time that the exhaust valve is open from the condition when it is most different from the normal combustion cycle to operation during a normal combustion cycle; or alternating between closed or more closed operation and normal or more close to normal combustion cycle operation. If the exhaust valve 29 is kept closed for at least one reciprocating movement of the piston 31 after injecting fuel, the fuel is expected to ordinarily mix better with the air than is likely to occur if fuel is simply introduced into the cylinder when the piston is proximate the TDC position. The transition may, in addition, comprise adjusting the length of time that the intake valve 27 is open relative to operation during normal combustion, and may include keeping it completely or partially closed or completely or partially open for one or more reciprocating movements of the piston 31. The intake valve 27 will, however, be controlled to stay open during at least one of the compression and/or exhaust movements when the exhaust valve is closed.

According to another aspect of the method, fuel can be injected into the cylinder 25 during at least an initial reciprocating movement of the piston 31, i.e., the steps shown in FIGS, la and lb can be omitted. The piston 31 can subsequently be reciprocated while maintaining the exhaust valve 29 closed for at least one reciprocating movement of the piston after injecting fuel to increase temperature of the mixture and better mix the air and fuel. The fuel injector 33 may inject fuel at any desired point during cranking, such as early during cranking, in a single injection, or in multiple, separate injection events, as shown at step 109-3 of FIG. 3. When a predetermined temperature in the cylinder 25 is reached, provided other necessary conditions for combustion are met in the cylinder, ignition of the fuel can occur when the piston 31 reaches a position proximate TDC, and opening and closing of the intake valve and the exhaust valve 29 according to a normal combustion cycle can be commenced. Alternatively, subsequent to combustion of the fuel when the piston is proximate the TDC position, the exhaust valve 29 can be opened during an exhaust stroke of the piston, then the piston can be moved through a plurality of reciprocating movements between the TDC and the BDC positions with the exhaust valve closed. In this way, the engine can be gradually heated to a desired temperature while there is periodic combustion in the cylinders.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A method for starting an engine, the engine comprising at least one cylinder arrangement comprising a cylinder with at least one intake valve and at least one exhaust valve, a fuel injector for injecting fuel into the cylinder, a piston adapted to reciprocate in the cylinder between a TDC position and a BDC position through an intake movement, a compression movement, an expansion movement, and an exhaust movement, and means for opening and closing the exhaust valve, the opening and closing means opening and closing the exhaust valve according to a normal combustion cycle during normal operation of the engine, the method comprising:
injecting fuel into the cylinder; and
reciprocating the piston in the cylinder through a plurality of reciprocating movements between the TDC and BDC positions while maintaining the exhaust valve closed for longer than during the normal combustion cycle for at least one reciprocating movement of the piston after injecting fuel.

2. The method as set forth in claim 1, comprising opening and closing the intake valve and the exhaust valve according to the normal combustion cycle for at least one reciprocating movement of the piston after injecting fuel.

3. The method as set forth in claim 1, comprising sensing a temperature in at least one of the cylinder and an intake manifold and opening and closing the intake valve and exhaust valve according to the normal combustion cycle only after a sensed temperature reaches a predetermined temperature.

4. The method as set forth in claim 1, comprising injecting no fuel into the cylinder during at least one reciprocating movement subsequent to fuel injection.

5. The method as set forth in claim 1, comprising injecting fuel into the cylinder during at least an initial reciprocating movement of the piston.

6. The method as set forth in claim 1, comprising injecting fuel into the cylinder, igniting the fuel when the piston is proximate the TDC position, and, after igniting the fuel, reciprocating the piston in the cylinder through a plurality of reciprocating movements between the TDC and the BDC positions with the exhaust valve closed for longer than during normal combustion cycle.

7. The method as set forth in claim 1, comprising injecting fuel into the cylinder and moving the cylinder through sufficient reciprocating movements until a temperature in the cylinder is sufficiently high that the fuel ignites.

8. The method as set forth in claim 1, comprising injecting fuel into the cylinder in a plurality of separate injection events.

9. The method as set forth in claim 1, comprising reciprocating the piston in the cylinder through a plurality of reciprocating movements between the TDC and the BDC positions with the intake valve closed for a different length of time than during the normal combustion cycle.

10. The method as set forth in claim 1, comprising igniting the fuel in the cylinder via compression ignition.

11. An engine, comprising:
a cylinder arrangement including a cylinder, an intake valve and an exhaust valve for opening and closing flow communication with the cylinder, through an intake movement, a compression movement, and expansion movement, and an exhaust movement, a fuel injector adapted to inject fuel into the cylinder, and means for opening and closing the exhaust valve, the opening and closing means opening and closing the exhaust valve according to a normal combustion cycle during normal operation of the engine; and
a controller adapted to control fuel injection into the cylinder and opening and closing of the intake valve and the exhaust valve, the controller being arranged to control when fuel is injected into the cylinder and to maintain the exhaust valve closed for longer than during the normal combustion cycle for at least one reciprocating movement of the piston after injecting fuel.

12. The engine as set forth in claim 11, comprising a temperature sensor for sensing temperature in the cylinder by sending a signal to the controller corresponding to the temperature in the cylinder, wherein the controller is arranged to control the fuel injector to inject fuel only after temperature in the cylinder has reached a predetermined temperature.

13. The engine as set forth in claim 11, wherein the controller is arranged to maintain the intake valve in a closed position for a different length of time than during the normal combustion cycle while the piston is reciprocated in the cylinder through a plurality of reciprocating movements between the TDC and the BDC positions.

14. The engine as set forth in claim 11, comprising a plurality of cylinder arrangements, wherein, for each cylinder arrangement, the intake valve is adapted to open and close flow communication between a respective cylinder and an intake manifold, and, for each cylinder arrangement, the controller being arranged to maintain the exhaust valve in the closed position for longer than during the normal combustion cycle while the piston is reciprocated in the cylinder through a plurality of reciprocating movements.

15. The engine as set forth in claim 11, wherein the engine is a compression ignition engine.

16. A method for starting an engine, the engine comprising at least one cylinder arrangement comprising a cylinder with at least one intake valve and at least one exhaust valve, a fuel injector for injecting fuel into the cylinder, a piston adapted to reciprocate in the cylinder between a TDC position and a BDC position through an intake movement, a compression movement, an expansion movement, and an exhaust movement, and means for opening and closing the exhaust valve, the opening and closing means opening and closing the exhaust valve according to a normal combustion cycle during normal operation of the engine, the method comprising:
reciprocating the piston in the cylinder through a plurality of reciprocating movements between the TDC and the BDC positions with the exhaust valve closed for longer than during the normal combustion cycle and the intake valve open for at least part of at least one of the compression movement and the exhaust movement while the exhaust valve is closed; and
opening and closing the intake valve and the exhaust valve according to the normal combustion cycle only after at least one of a predetermined number of reciprocating movements have been performed and a predetermined temperature has been reached in at least one of the cylinder and an intake manifold.

17. The method as set forth in claim 16, comprising injecting no fuel into the cylinder during at least one initial reciprocating movement of the piston.

18. The method as set forth in claim 17, comprising injecting fuel into the cylinder subsequent to at least one initial reciprocating movement of the piston.

19. The method as set forth in claim 18, comprising maintaining the exhaust valve closed for longer than during the normal combustion cycle for at least one reciprocating movement of the piston after injecting fuel.

20. The method as set forth in claim 16, comprising injecting fuel into the cylinder and, during at least one reciprocating movement subsequent to fuel injection, injecting no fuel into the cylinder.

21. The method as set forth in claim 16, comprising injecting fuel into the cylinder, injecting the fuel when the piston is proximate the TDC position, and, after igniting the fuel, reciprocating the piston in the cylinder through a plurality of reciprocating movements between the TDC and the BDC positions with the exhaust valve closed for longer then during the normal combustion cycle.

22. The method as set forth in claim 16, comprising injecting fuel into the cylinder and moving the cylinder through sufficient reciprocating movements until a temperature in the cylinder is sufficiently high that the fuel ignites.

23. the method as set forth in claim 16, comprising injecting fuel into the cylinder in a plurality of separate injection events.

24. The method as set forth in claim 16, comprising reciprocating the piston in the cylinder through a plurality of reciprocating movements between the TDC and the BDC positions with the intake valve closed for a different length of time than during the normal combustion cycle.

25. The method as set forth in claim 16, comprising sensing a temperature in at least one of the cylinder and intake manifold and opening and closing the intake valve and the exhaust valve according to the normal combustion cycle only after a sensed temperature reaches a predetermined temperature.

26. The method as set forth in claim 16, comprising igniting the fuel in the cylinder via compression ignition.

27. An engine, comprising:
a cylinder arrangement including a cylinder, an intake valve and an exhaust valve for opening and closing flow communication with the cylinder, a piston adapted to reciprocate between a TDC position and a BDC position in the cylinder through an intake movement, a compression movement, an expansion movement, and an exhaust movement, a fuel injector adapted to inject fuel into the cylinder, and means for opening and closing the exhaust valve, the opening and closing means opening and closing the exhaust valve according to a normal combustion cycle during normal operation of the engine;
a controller adapted to control fuel injection into the cylinder and opening and closing of the intake valve and the exhaust valve, the controller being arranged to maintain the exhaust valve in a closed position for longer than during the normal combustion cycle and the intake valve open for at least part of at least one of the compression movement and the exhaust movement while the exhaust valve is closed while the piston is reciprocated in the cylinder through a plurality of reciprocating movements between the TDC and the EDC positions, to open and close the intake valve and the exhaust valve according to the normal combustion cycle only after at least one of a predetermined number of reciprocating movements have been performed and a predetermined temperature has been reached in at least one of the cylinder and an intake manifold.

28. The engine as set forth in claim 27, comprising a plurality of cylinder arrangements, wherein, for each cylinder arrangement, the intake valve is adapted to open and close flow communication between a respective cylinder and an intake manifold, and, for each cylinder arrangement, the controller being arranged to maintain the exhaust valve in the closed position for longer than during the normal combustion cycle while the piston is reciprocated in the cylinder through the plurality of reciprocating movements.

29. The engine as set forth in claim 27, comprising a temperature sensor for sensing a temperature in at least one of the cylinder and the intake manifold, wherein the controller is arranged to determine whether the temperature sensed in the at least one of the cylinder and the intake manifold has reached a predetermined temperature, and to open and close the intake valve and the exhaust valve according to the normal combustion cycle in response to a determination that the sensed has reached the predetermined temperature.

30. The engine as set forth in claim 29, wherein the controller is arranged to control the fuel injector to inject fuel only after the temperature in the cylinder has reached the predetermined temperature.

31. The engine as set forth in claim 27, wherein the engine is a compression ignition engine.
